(19) United States
(12) Patent Application Publication
(10) Pub. No.: US 2007/0162909 A1
(43) Pub. Date: Jul. 12, 2007

(54) Reserving resources in an operating system

(75) Inventors: Pradeep Bahl, Redmond, WA (US); Narasimha Rao S. S. Nagampalli, Kirkland, WA (US); Ramesh Chinta, Sammamish, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/329,984

(22) Filed: Jan. 11, 2006

(51) Int. Cl. G06F 9/46

(52) U.S. Cl. 718/104

(57) ABSTRACT

Techniques for reserving resources in an operating system are provided. The techniques include receiving an indication of an authorization setting specifying a directive and identifying at least a resource, an action, and a principal, configuring to apply the specified directive in relation to the identified action and resource when the principal attempts to perform the identified action in relation to the indicated resource, determining that the principal is attempting to perform the identified action on the identified resource, and applying the specified directive. The techniques function whether or not the resources or principals exist when the resources are reserved.

### BACKGROUND

An operating system performs various tasks relating to a computer system, such as managing hardware, software, operating, and network resources. Hardware resources include processors, primary storage (e.g., memory), secondary storage (e.g., hard disk or optical disk), printers, display adapters, network interface cards, input/output ports, etc. Software resources include application programs, user interfaces, device drivers, etc. Operating resources include files, registry keys, named pipes, etc. Network resources include network ports (e.g., relating to a transport control protocol (“TCP”), internet protocol (“IP”), user datagram protocol (“UDP”)), subnets, addresses, interface cards, network protocol stacks, etc. The operating system manages and coordinates these resources to complete various tasks, such as under the direction of an application program, service, or other software (referred to herein as an operating system component). Resources are sometimes referred to as “objects” in the art.

Malicious software (“malware”) is a type of software that is generally harmful to computer systems or operating systems. Malware includes computer worms, viruses, Trojan horses, spyware, and so forth. Some malware behave nefariously, such as by illicitly collecting and transmitting personal information. Some malware can hijack resources needed by operating system components or use these resources to subvert the security of the operating system. For example, such malware can cause an unprotected network resource to open a TCP/IP port that allows a third party to access the operating system's resources.

Conventional techniques of detecting and disabling malware include installing anti-malware software and hardware products, such as antiviral software, spyware detection software, firewalls, and so forth. Unfortunately, anti-malware products have not been entirely successful because software developers who create malware have adapted to these anti-malware products.

### SUMMARY

A facility is described for reserving resources associated with an operating system for identified principals, whether or not such resources and principals have already been created. By reserving operating system resources, the facility prevents subversion or hijacking of the resources. Principals of an operating system include, but are not limited to, the operating system's users, applications, services, and virtual machines. Neither the resource nor the principal needs to exist when the facility reserves the resource for the principal. A principal can reserve a resource for itself or another principal. The reservations may be conditional. The facility can reserve various resources of the operating system including, e.g., files, folders, registry keys, registry hives, physical and virtual network interfaces, virtual local area networks, IP addresses or ranges, IP subnets, TCP ports, UDP ports, applications, services, processor time, network bandwidth, storage space, or any other identifiable resource. The facility can employ an access control mechanism to make reservations, such as by using a system protection service offered by an operating system.

The facility can receive authorization settings that provide an indication of resources that are to be reserved for indicated principals such as when a principal is installed. The authorization settings can indicate what actions principals can or cannot take in relation to an indicated resource. When the facility receives these reservations, it may provide the authorization settings to appropriate kernel mode and user mode operating system components that can reserve the resources. When a principal attempts to perform an action in relation to a resource, a kernel mode component or a user mode component may determine whether the principal is authorized to perform the requested action. If the principal is not so authorized, the kernel mode component or the user mode component may prevent the action from occurring.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example of a suitable computing environment in which the facility may operate.

FIGS. 2-3 are block diagrams illustrating configurations of the facility in various embodiments.

FIG. 4 is a flow diagram illustrating a configure routine invoked by the facility in some embodiments.

FIG. 5 is a flow diagram illustrating a user mode load_configuration_settings routine invoked by the facility in some embodiments.

FIG. 6 is a flow diagram illustrating a kernel mode load_configuration_settings routine invoked by the facility in some embodiments.

FIG. 7 is a flow diagram illustrating an enforce routine invoked by the facility in some embodiments.

### DETAILED DESCRIPTION

A facility is described for reserving resources associated with an operating system for identified principals, whether or not such resources and principals have already been created (“the facility”). By reserving operating system resources, the facility prevents subversion or hijacking of the resources. Principals of an operating system include, but are not limited to, the operating system's users, applications, services, and virtual machines. Principals can be identified by globally unique identifiers, names, paths, and so forth. As an example, an application can employ the facility to reserve a registry hive and a set of TCP/IP ports. A registry hive is a collection of registry keys. When the facility reserves a resource for a principal, the facility authorizes the principal to take various actions on the reserved resource and may prevent other principals (including malware) from creating, accessing, or using the resource. As an example, when the facility reserves a file for an identified principal, the facility authorizes that principal to create the file if the file does not yet exist. As another example, if the facility reserves a registry hive for a service, the facility authorizes the service to add registry keys to the registry hive but prevents other services and applications from doing so. By enabling reservation of resources for principals, the facility is able to prevent hijacks or other malicious use of reserved resources by malware. In various embodiments, a principal can reserve a resource for itself or another principal. As an example, an application can, during its installation reserve a network port for its sole use. As another example, the operating system or some other principal can reserve a filename or file folder for use by a principal (e.g., an application or service) that has not yet been installed. As another example, when the facility reserves a resource that does not yet exist for a principal, whether or not that principal already exists, only that identified principal may be able to create the specified resource. Thus, principals can reserve resources or benefit from the reservation of resources whether or not the resources or principals already exist when the reservation is made.

The facility can receive authorization settings that provide an indication of resources that are to be reserved for indicated principals, such as when a principal is installed. The authorization settings indicate what actions principals can or cannot take in relation to an indicated resource. When the facility receives these reservations, it provides the authorization settings to appropriate kernel mode and user mode operating system components that can reserve the resources. When a principal attempts to perform an action in relation to a resource, a kernel mode component or a user mode component first determines whether the principal is authorized to perform the requested action. If the principal is not so authorized, the kernel mode component or the user mode component prevents the action from occurring.

Neither the resource nor the principal needs to exist when the facility reserves the resource for the principal. As an example, the facility enables a principal to reserve a TCP/IP port even though that port does not exist until the principal creates it. As another example, the facility may reserve a particular TCP/IP port for an application even though that application has not been installed on the operating system. In some embodiments, the facility can reserve any resource that is identifiable. As an example, the facility can reserve a non-existent resource that has a name or identifier.

The reservations may be conditional. As an example, a media player application may be able to download media only during specified times. Conditions can include start time, end time, geographic or network location, a state or other attribute of the operating system or the computer system, occurrence of various events, reputation rating, risk profile, and so forth, and may be combined with logical operators to form complex conditions. These conditions can relate to principals, resources, users, or other aspects of the operating system or facility. As an example, a principal having a poor reputation rating may be unable to open a network port that does not exist. As another example, a user having a high risk profile may be unable to download an ACTIVEX control from a web site that is not indicated to be trusted. Thus, the facility can provide conditional directives. A directive may indicate an action on a resource that is to be authorized or denied.

The facility can reserve various resources of the operating system including, e.g., files, folders, registry keys, registry hives, physical and virtual network interfaces, virtual local area networks, IP addresses or ranges, IP subnets, TCP ports, UDP ports, applications, services, mutexes, semaphores, processor time, network bandwidth, storage space, or any other identifiable resource. The resources may be identified in a type-specific way. As an example, a file or folder can be identified by a path whereas an IP address or IP subnet can be identified by an IP number.

In some embodiments, the facility employs an access control mechanism to make reservations. As an example, the facility employs a system protection service (“SPS”) of the MICROSOFT WINDOWS operating system. The SPS can determine whether access control permissions on a resource indicate whether a requested operation should be authorized or denied. In some embodiments, the SPS intervenes when an operating system component makes a reservation relating to a nonexistent resource. The facility receives indications of access control and directs the SPS to enforce access control permissions accordingly. The facility may receive the indications of access control from principals, a user, a configuration file, and so forth. The indications of access control are sometimes referred to as access control rules, access control constructs, access control settings, authorization settings, and so forth.

In various embodiments, the facility employs white-list and black-list authorizations as authorization settings. When the facility employs white-list authorization, the facility can allow authorized principals to take various actions. As an example, the facility can allow a principal to “listen” for connections on a specified TCP port. The facility may receive this white-list authorization setting from a principal as follows:
T(P1-WC-TCP){ALLOW OPEN <sid1>}

In this authorization setting, the “T” before the first parenthesis indicates that the authorization applies to a transport-layer resource. The “P1” after the first parenthesis indicates that the resource is source port number P1. The “WC” indicates that the port P1 can be open on any source IP address. “WC” is an acronym for “wildcard.” “TCP” is the transport-layer protocol. The “ALLOW OPEN <sid1>” in the braces indicates that the authorization is to allow the principal identified by <sid1> to open the port. A “sid” is an identifier, such as a globally unique identifier, for a principal. The “<sid1>” is an identifier for a principal. According to this authorization setting, any other principal (e.g., a principal that is not identified by <sid1>) should not be able to open the port.

When the facility employs black-list authorization, the facility can deny specified unauthorized principals from taking various actions. As an example, the facility can deny a principal identified as <sid2> from opening a port P1 on a network address A1 using the following authorization setting:
T(P1-A1){DENY OPEN <sid2>}

Thus, the facility employs authorization settings to indicate a directive in relation to actions a principal attempts to take on a resource, even when the resource does not yet exist in the operating system.

In some embodiments, when a white-list authorization is defined, the facility may automatically deny principals who are not provided sufficient authorization. In various embodiments, when no authorization is defined (e.g., black-list or white-list), all principals are either provided authorization or denied authorization depending on a default setting indicated to the facility.

In general, the facility accepts authorization settings that are indicated as resources followed by authorizations. An example of a resource is a network object, such as a TCP/IP port. Network objects can be indicated using one or more values, which may be referred to as a “1-tuple,” “2-tuple,” “3-tuple,” “4-tuple,” “5-tuple,” and so forth. These values appear as a tuple in parentheses near an indication of the network object type to which the tuple relates. Network objects generally relate to various network layers. In various embodiments, there can be a one-to-one relationship between a “network layer” as defined in the Open Systems Interconnect (“OSI”) network communications model and a “network object” type. One or more authorizations specified within braces can follow an indicated network object type. Authorizations are generally specified as ALLOW or DENY followed by an action that the facility is to allow or deny and then an indication of a set of principals. Table 1 provides additional examples of authorization settings.

TABLE 1
Examples of Authorization settings

| Authorization setting | Meaning |
|---|---|
| T(1024-65535) {ALLOW OPEN CertAppGrpSid} | Transport-layer ports in the range 1024 to 65535 are |
| | reserved for principals in the CertAppGrpSid group, any |
| | of which is allowed to open a port in the indicated range. |
| | No principal that is not in the CertAppGrpSid group can |
| | use any port in this range. |
| (HKLM\System\CCS\Services\WINS) {ALLOW | Only the principal identified by WINSSid can create |
| CREATE WINSSid} | registry keys in the |
| | HKeyLocalMachine\System\CCS\Services\WINS |
| | registry hive. |
| (<URL>) {DENY GET childsid} {ALLOW GET | The principal identified by childsid cannot access the |
| adultsid} | URL indicated by <URL>, but the principal identified by |
| | adultsid can. |
| T(WC, 123.45.6.7) {ALLOW OPEN | No principal other than the one identified by |
| DHCPServerSid) | DHCPServerSid can use the IP address 123.45.6.7, no |
| | matter which source IP address (e.g., identified by the |
| | wildcard WC) this principal uses. |
| T(WC, 123.45.*.*) {DENY OPEN AppGrpSid} | Allow any principal to use the IP subnet identified by |
| {ALLOW OPEN EVERYONE} | 123.45.*.* except principals identified by the group |
| | AppGrpSid. |
| D(VLANWorkGroupAId) {ALLOW OPEN | Any principal identified by the WorkGroupAppGrpSid |
| WorkGroupAppGrpSid} | group can open the data link layer object identified by |
| | VLANWorkGroupAId, which identifies a virtual local |
| | area network. |
| (%SystemRoot%\DHCP\dhcp.log {ALLOW | Only the principal identified by DHCPClientSid can |
| CREATE DHCPClientSid} | create a file named “dhcp.log” in the |
| | %SystemRoot%\DHCP\folder. |

The facility receives these authorization settings and provides them to various drivers and other components that enforce the authorizations indicated by the authorization settings. In various embodiments, the facility provides a filtering platform that receives plug-ins associated with various resource types. When a principal accesses a resource for which the facility has an associated plug-in, the facility requests the plug-in to determine whether an action requested by the principal should be allowed or denied. As an example, when an authorization setting reserves a particular transport-layer port for use only by principals identified by a group's “sid,” a transport layer plug-in of the facility that enforces the authorization setting can deny other principals that attempt to access that port. Thus, by reserving resources for principals, the facility is able to prevent some types of malware from operating successfully on an operating system configured to employ the facility.

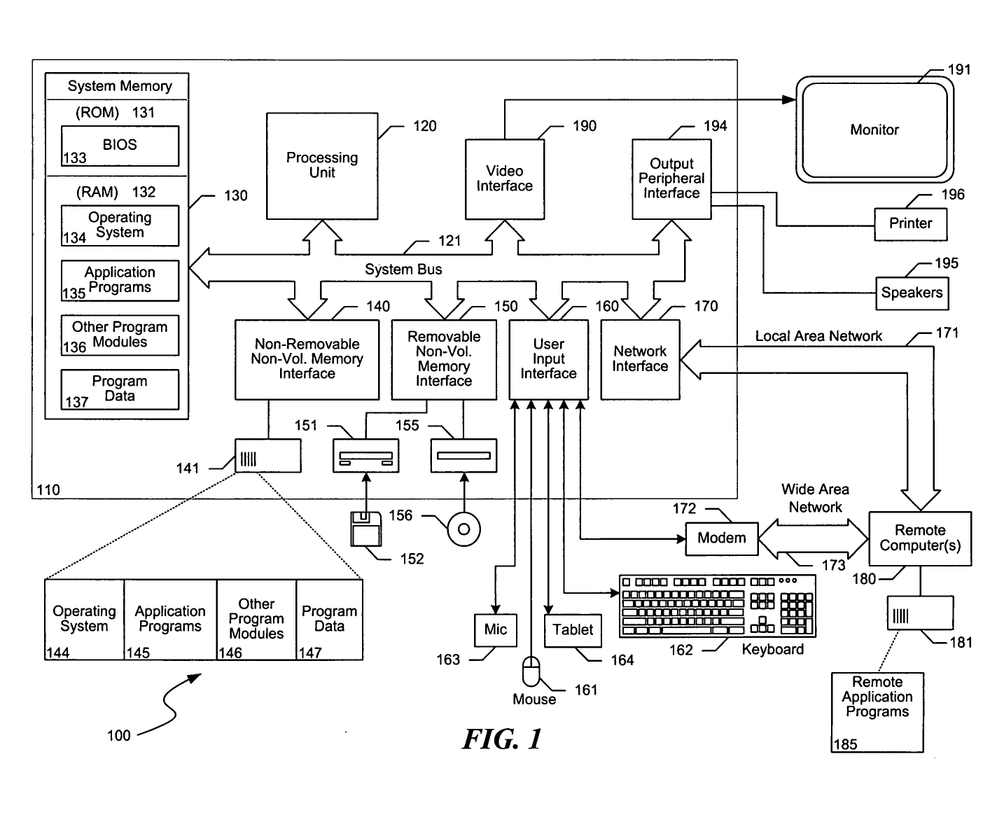

Turning now to the figures, FIG. 1 is a block diagram illustrating an example of a suitable computing system environment 110 or operating environment in which the techniques or facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary computing system 110.

The facility is operational with numerous other general purpose or special purpose computing system environments or configurations. Examples of well-known computing systems, environments, and/or configurations that may be suitable for use with the facility include, but are not limited to, personal computers, server computers, handheld or laptop devices, tablet devices, multiprocessor systems, microprocessor-based systems, set-top boxes, programmable consumer electronics, network PCs, minicomputers, mainframe computers, routers, switches, access points, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media, including memory storage devices.

With reference to FIG. 1, an exemplary system for implementing the facility includes a general purpose computing device in the form of a computer 100. Components of the computer 100 may include, but are not limited to, a processing unit 120, a system memory 130, and a system bus 121 that couples various system components, including the system memory 130 to the processing unit 120. The system bus 121 may be any of several types of bus structures, including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as a Mezzanine bus.

The computer 100 typically includes a variety of computer-readable media. Computer-readable media can be any available media that can be accessed by the computer 100 and include both volatile and nonvolatile media and removable and nonremovable media. By way of example, and not limitation, computer-readable media may comprise computer storage media and communications media. Computer storage media include volatile and nonvolatile and removable and nonremovable media implemented in any method or technology for storage of information, such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 100. Communications media typically embody computer-readable instructions, data structures, program modules, or other data in a modulated data signal, such as a carrier wave or other transport mechanism, and include any information delivery media. The term “modulated data signal” means a signal that has one or more of its characteristics set or changed in such a manner as to encode information in the signal. By way of example, and not limitation, communications media include wired media, such as a wired network or direct-wired connection, and wireless media, such as acoustic, RF, infrared, and other wireless media. Combinations of any of the above should also be included within the scope of computer-readable media.

The system memory 130 includes computer storage media in the form of volatile and/or nonvolatile memory, such as read only memory (ROM) 131 and random access memory (RAM) 132. A basic input/output system (BIOS) 133, containing the basic routines that help to transfer information between elements within the computer 100, such as during startup, is typically stored in ROM 131. RAM 132 typically contains data and/or program modules that are immediately accessible to and/or presently being operated on by the processing unit 120. By way of example, and not limitation, FIG. 1 illustrates an operating system 134, application programs 135, other program modules 136, and program data 137.

The computer 100 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/nonremovable, volatile/nonvolatile computer storage media that can be used in the exemplary computing system environment 110 include, but are not limited to, magnetic tape cassettes, flash memory cards, digital versatile disks, digital video tapes, solid state RAM, solid state ROM, and the like. The hard disk drive 141 is typically connected to the system bus 121 through a nonremovable memory interface, such as an interface 140, and the magnetic disk drive 151 and optical disk drive 155 are typically connected to the system bus 121 by a removable memory interface, such as an interface 150.

The drives and their associated computer storage media, discussed above and illustrated in FIG. 1, provide storage of computer-readable instructions, data structures, program modules, and other data for the computer 100. In FIG. 1, for example, the hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers herein to illustrate that, at a minimum, they are different copies. A user may enter commands and information into the computer 100 through input devices, such as a tablet or electronic digitizer 164, a microphone 163, a keyboard 162, and a pointing device 161, commonly referred to as a mouse, trackball, or touch pad. Other input devices not shown in FIG. 1 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch-screen panel can be physically coupled to a housing in which the computer 100 is incorporated, such as in a tablet-type personal computer. In addition, computing devices such as the computer 100 may also include other peripheral output devices such as speakers 195 and a printer 196, which may be connected through an output peripheral interface 194 or the like.

The computer 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 100, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprisewide computer networks, intranets, and the Internet. For example, in the present facility, the computer 100 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 100 is connected to the LAN 171 through a network interface or adapter 170. When used in a WAN networking environment, the computer 100 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 100, or portions thereof, may be stored in the remote memory storage device 181. By way of example, and not limitation, FIG. 1 illustrates remote application programs 185 as residing on the memory storage device 181. It will be appreciated that the network connections shown are exemplary and other means of establishing a communications link between the computers may be used.

While various functionalities and data are shown in FIG. 1 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

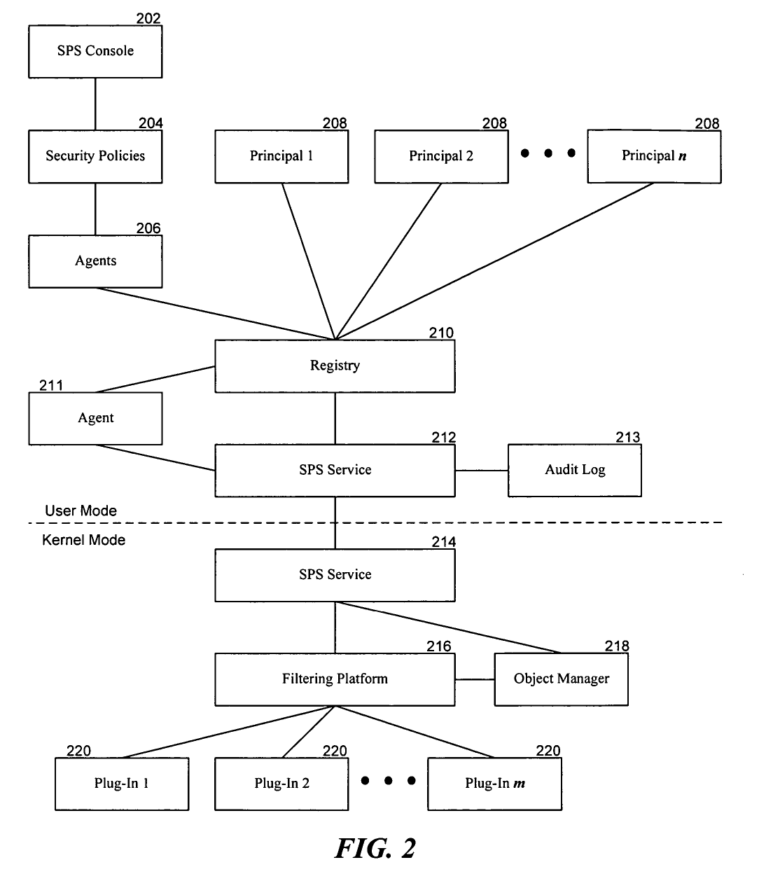

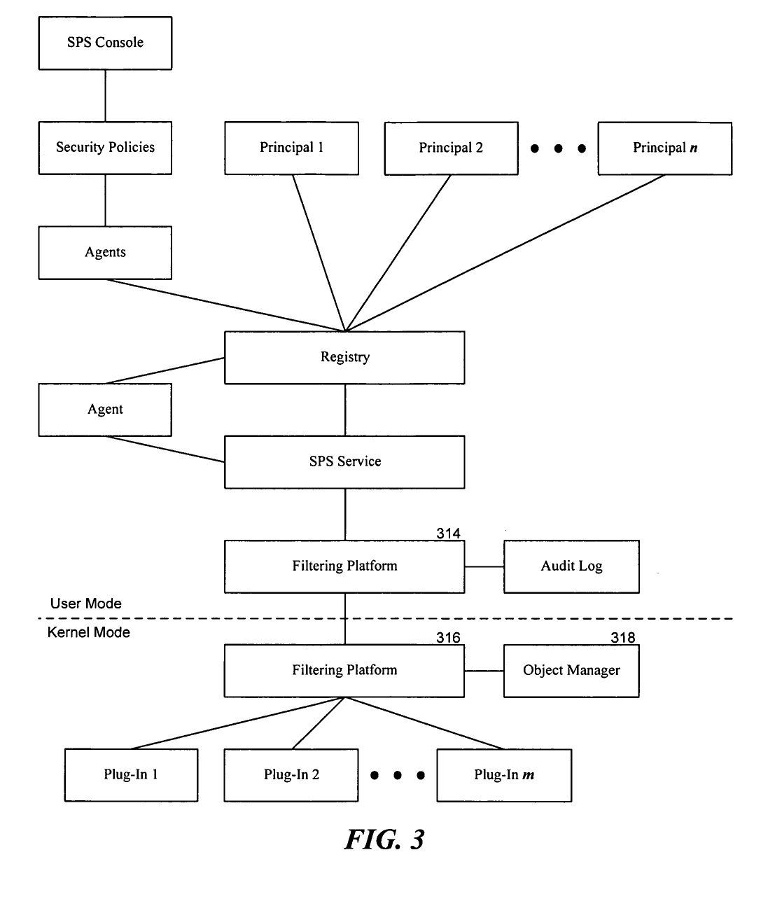

FIGS. 2-3 are block diagrams illustrating configurations of the facility in various embodiments. The configuration of the embodiment illustrated in FIG. 2 will be described first. Various components operate in user mode or kernel mode of the underlying operating system. The components that operate in user mode are illustrated above the dashed horizontal line. The components that operate in kernel mode are illustrated below this dashed horizontal line.

In the illustrated embodiment, the facility has a system protection service (“SPS”) console 202. The SPS console is a tool that an administrator can use to indicate security policies. The administrator can also use the SPS console to provide authorization settings for the facility. The SPS console registers security policies in a security policies component 204. As an example, the SPS console collects input from an administrator to define and store security policies in the security policies component. The SPS console can also register settings in an external repository, such as in MICROSOFT ACTIVE DIRECTORY or MICROSOFT SQL SERVER.

One or more agents 206 may process the security policies that are stored in the security policies component or an external repository to create registry entries that the facility uses to reserve resources. These agents may transform the security policies into authorization settings and store these authorization settings in the registry 210.

Various principals 208 may also register security policies in the security component or store authorization settings in the registry, such as by employing an application program interface (“API”) provided by the facility. Examples of such principals include application installers, parental control applications, services (e.g., daemons), applications, and so forth.

In the illustrated embodiment, a user mode component of the SPS service component 212 communicates authorization settings from user mode to kernel mode in addition to performing other activities. An agent 211 may provide authorization settings stored in the registry to the SPS service user mode component. As an example, the agent may invoke an API provided by the SPS service user mode component to translate the authorization settings stored in the registry for use by the SPS service. The SPS service user mode component may store information relating to its activities in an audit log 213. As an example, the SPS service may employ the audit log to store changes to authorization settings, successful or failed attempts to reserve resources, and so forth.

The SPS service also has a kernel mode component 214, such as a kernel mode driver. The SPS service employs the kernel mode component to provide authorization settings to other kernel mode components. As an example, the SPS service kernel mode component may provide authorization settings to a filtering platform 216, such as WINDOWS FILTERING PLATFORM. The filtering platform provides an API that principals or other operating system components can use to examine, send, remove, or modify TCP/IP packets.

The filtering platform may additionally have one or more plug-ins 220 that enable the filtering platform to provide similar services for other resources, such as for hypertext transfer protocol, remote procedure calls, and so forth. When the operating system evaluates permissions for resources (e.g., files, registry keys, etc.), the operating system may employ an object manager 218 to provide various information, such as information pertaining to permissions. The object manager may in turn request the SPS service kernel mode component to provide this information to it, e.g., by communicating with the SPS service user mode component.

The embodiment illustrated in FIG. 3 is similar to the embodiment illustrated in FIG. 2 except that whereas components of the SPS service enable communication of information between user and kernel modes in the embodiment illustrated in FIG. 2, components of the filtering platform perform this work in the embodiment illustrated in FIG. 3. The filtering platform has a user mode component 314 and a kernel mode component 316. The embodiment illustrated in FIG. 3 does not have a kernel mode SPS service component. The object manager 318 provides information to the operating system via the filtering platform kernel mode component.

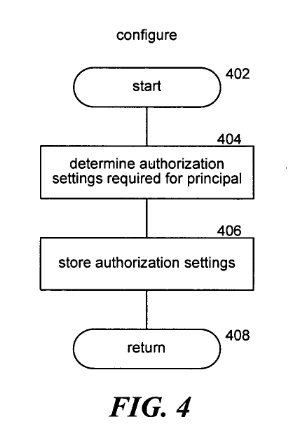

FIG. 4 is a flow diagram illustrating a configure routine invoked by the facility in some embodiments. A principal or an appropriately privileged program may invoke the configure routine to reserve resources that the principal uses. As an example, the principal may invoke the configure routine when the application is installed. The principal could also invoke the configure routine after or before application installation. The routine begins at block 402.

At block 404, the routine determines authorization settings that the invoker of the routine requires. The routine may make that determination by checking a manifest provided by the principal that invoked the routine. As an example, an installation program may provide a manifest file to the facility indicating which files, registry keys, TCP/IP ports, or other resources that an application being installed requires. In some embodiments, the principal may invoke an API provided by the facility to configure the facility. In these embodiments, the principal may provide authorization settings directly, in which case the facility may not perform the logic associated with block 404.

At block 406, the routine stores the determined or received authorization settings. The routine may store these authorization settings in a registry, file, database, or so forth. In some embodiments, the facility may store the authorization settings in a secure portion of the registry. As an example, this portion of the registry may only be modified by a system administrator.

At block 408, the routine returns.

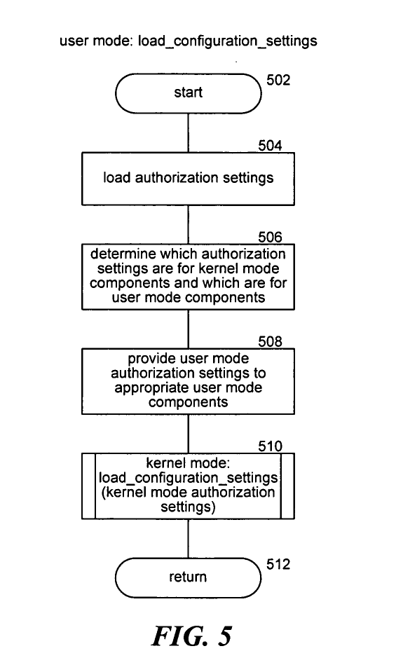

FIG. 5 is a flow diagram illustrating a user mode load_configuration_settings routine invoked by the facility in some embodiments. In various embodiments, a user mode component of the SPS service or filtering platform invokes the load_configuration_settings routine. As examples, the user mode component of the SPS service illustrated in the embodiment of FIG. 2 or the user mode component of the filtering platform illustrated in the embodiment of FIG. 3 may invoke the routine. These components may invoke the routine to provide stored authorization settings to the appropriate components of the facility or operating system. The routine begins at block 502.

At block 504, the routine loads the stored authorization settings. As an example, the routine may load the stored authorization settings from a registry, file, database, or so forth.

At block 506, the routine determines which of the loaded authorization settings are for kernel mode components and which are for user mode components. The routine may make that determination based on which operating system the facility operates in. As an example, the facility may employ a kernel mode component to reserve networking resources but may employ a user mode component to reserve file system resources.

At block 508, the routine provides user mode authorization settings to user mode components to which the authorization settings relate. As an example, the routine may provide authorization settings for reserving files to a user mode operating system component.

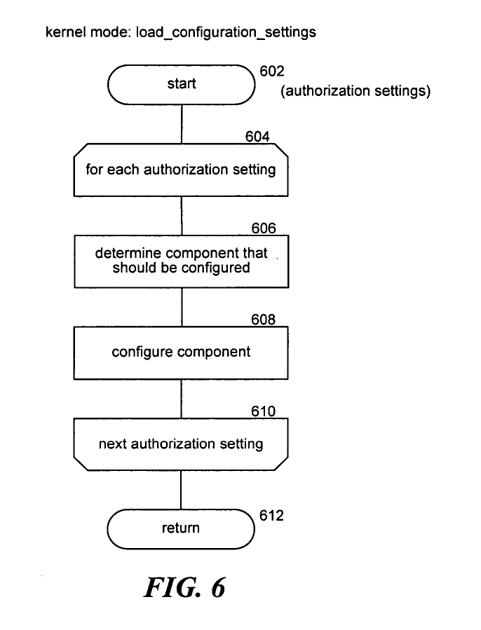

At block 510, the routine invokes a load_configuration_settings subroutine performed by a kernel mode component to provide the kernel mode authorization settings to appropriate kernel mode components. As an example, the routine may invoke a kernel mode SPS service component or a kernel mode filtering platform component. The routine may provide an indication of the loaded kernel mode authorization settings to the kernel mode load_configuration_settings subroutine. This subroutine is described in further detail below in relation to FIG. 6.

At block 512, the routine returns.

FIG. 6 is a flow diagram illustrating a kernel mode load_configuration_settings routine invoked by the facility in some embodiments. The routine begins at block 602 where it receives indications of authorization settings as one or more parameters. The routine may be invoked to provide the authorization settings to kernel mode components that the facility employs to reserve various resources.

Between the loop of blocks 604 to 610, the routine determines which kernel mode components should be configured based on the received authorization settings and configures these components. At block 604, the routine selects an authorization setting.

At block 606, the routine determines which kernel mode component corresponds to the selected authorization setting. As an example, the routine may determine that a networking plug-in of the filtering platform corresponds to an authorization setting indicating that a TCP/IP port is to be reserved for a principal.

At block 608, the routine configures the kernel mode component that the routine identified at block 606. As an example, the routine may provide the selected authorization settings to the identified component. In some embodiments, the routine may configure the identified component by varying properties associated with the component.

At block 610, the routine selects another authorization setting. When all received authorization settings have been processed, the routine continues at block 612, where it returns. Otherwise, the routine continues at block 606.

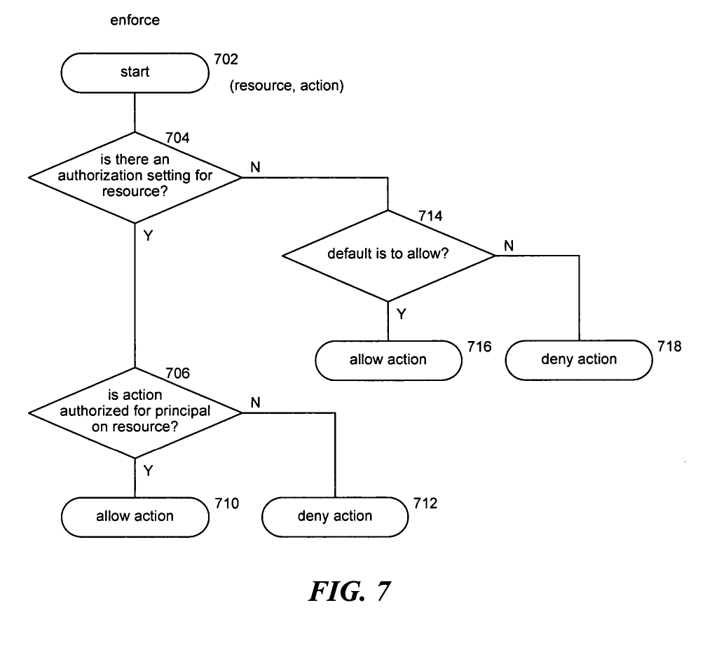

FIG. 7 is a flow diagram illustrating an enforce routine invoked by the facility in some embodiments. Various components of the facility may invoke the enforce routine when a principal attempts to take an action on a resource. As an example, a filtering platform plug-in corresponding to TCP/IP traffic handled by a computing device associated with the facility may invoke the enforce routine when an application attempts to open a TCP/IP port. The routine begins at block 702 where it receives indications of a resource and an action as parameters. In some embodiments, the routine additionally receives an indication of a principal attempting to take the action on the resource.

At block 704, the routine determines whether there is an authorization setting associated with the indicated resource. If there is an indicated authorization setting associated with the resource, the routine continues at block 706. Otherwise, the routine continues at block 714.

At block 706, the routine determines whether the principal is authorized to take the indicated action on the indicated resource. If the principal is so authorized, the routine continues at block 710 where it allows the action to proceed and returns. Otherwise, the routine continues at block 712 where it denies the action and returns.

At block 714, the routine determines whether a default authorization to allow the action is indicated. If the facility is configured to allow actions by default when no authorization setting exists for a resource on which a principal attempts to take an action, the routine continues at block 716 where it allows the action and returns. Otherwise, the routine continues at block 718 wherein it denies the action and returns.

Those skilled in the art will appreciate that the blocks illustrated in FIGS. 4-7 and described above may be altered in a variety of ways. For example, the order of the blocks and their associated logic may be rearranged, additional logic may be performed in parallel, shown blocks may be omitted, or other blocks and associated logic may be included, and so forth.

It will be appreciated by those skilled in the art that the above-described facility may be straightforwardly adapted or extended in various ways. For example, the facility can be adapted to reserve processor time, network bandwidth, disk space, and so forth. While the foregoing description makes reference to particular embodiments, the scope of the invention is defined solely by the claims that follow and the elements recited therein.

We claim:

1. A computer-readable medium having computer-executable instructions for performing a method of reserving resources in an operating system, the method comprising:
receiving an indication of an authorization setting, the authorization setting identifying at least an operating system resource and an action that a principal can attempt to perform in relation to the operating system resource, the operating system resource not yet created in the operating system, the authorization setting specifying at least a directive that corresponds to the identified operating system resource and action, the directive indicating whether the identified action is to be allowed or denied;
selecting from a set of enforcement components corresponding to the operating system an enforcement component that is to enforce the specified directive, the enforcement component operating either in a user mode or a kernel mode of the operating system and configurable to apply the directive on actions the principal attempts to take on the identified operating system resource; and
providing an indication of the received authorization setting to the selected enforcement component so that the selected enforcement component can configure itself to apply the specified directive in relation to the identified action and operating system resource when the principal attempts to perform the identified action even when the operating system resource has not yet been created in the operating system.

2. The computer-readable medium of claim 1 wherein the receiving includes loading indicated the authorization setting from a registry.

3. The computer-readable medium of claim 1 wherein the receiving includes receiving a set of authorization settings and wherein the selecting further comprises determining whether a subset of the received set of authorization settings relates to user mode or kernel mode operating system components.

4. The computer-readable medium of claim 3 wherein the providing further comprises providing an indication of the determined subset of authorization settings relating to kernel mode components to a kernel mode component that, for each such authorization setting, selects a kernel mode plug-in that applies the directive specified by the authorization setting and provides the indication of the authorization setting to the selected kernel mode plug-in.

5. A system for reserving resources in an operating system, comprising:
an operating system having a storage that stores authorization settings;
an operating system component that has a user mode subcomponent and a kernel mode subcomponent wherein the user mode subcomponent receives indications of authorization settings that are stored in the operating system's storage; and
an enforcement component that configures itself to enforce directives specified in the authorization settings and enforces the directives when a principal attempts to perform an action in relation to a resource, the action and resource indicated in the authorization setting that the operating system component received, the enforcement component operating in kernel mode.

6. The system of claim 5 wherein the authorization setting indicates that the directive corresponds to a type of resource.

7. The system of claim 5 wherein the resource is a transport layer resource.

8. The system of claim 7 wherein the resource is a TCP/IP port.

9. The system of claim 7 wherein the directive is conditional.

10. The system of claim 9 wherein the condition specifies a time or a location.

11. The system of claim 5 wherein the directive is to deny the action.

12. The system of claim 11 wherein the action is to open a TCP/IP port.

13. The system of claim 11 wherein the action is to create a file.

14. The system of claim 5 wherein the directive is to allow the action.

15. The system of claim 14 wherein the directive is to open a file for writing.

16. A method performed by a computer system for reserving resources in an operating system, comprising:
receiving an indication of an authorization setting that identifies at least a resource, an action, and a principal, the authorization setting specifying a directive that corresponds to the identified resource, action, and principal;
configuring to apply the specified directive in relation to the identified action and resource when the principal attempts to perform the identified action in relation to the identified resource;
determining that the principal is attempting to perform the identified action on the identified resource; and
applying the specified directive.

17. The method of claim 16 wherein the receiving includes receiving an indication of an authorization setting specifying that a network interface card is to be reserved for the principal.

18. The method of claim 16 wherein the configuring includes configuring to apply the specified directive even when the identified resource does not exist on the operating system.

19. The method of claim 16 wherein the configuring includes configuring to apply the specified directive even when the identified principal does not exist on the operating system.

20. The method of claim 16 wherein the configuring includes configuring to apply the specified directive even when the applying includes allowing the action.
